(19) United States
(12) Patent Application Publication
(10) Pub. No.: US 2025/0029517 A1
(43) Pub. Date: Jan. 23, 2025

(54) PROCEDURE SIMULATOR

(71) Applicant: TERUMO KABUSHIKI KAISHA, Tokyo (JP)

(72) Inventor: Kouji OZAKI, Kanagawa (JP)

(73) Assignee: TERUMO KABUSHIKI KAISHA, Tokyo (JP)

(21) Appl. No.: 18/904,442

(22) Filed: Oct. 2, 2024

Related U.S. Application Data
(63) Continuation of application No. PCT/JP2023/019849, filed on May 29, 2023.

(30) Foreign Application Priority Data
Jun. 3, 2022 (JP) 2022-090793

(51) Int. Cl. G09B 23/30

(52) U.S. Cl. CPC G09B 23/30

(57) ABSTRACT

A procedure simulator for training a procedure using a balloon catheter includes a first flow path simulating a vena cava of a human body; and a second flow path simulating a second venous system of the human body independent of the vena cava. The first flow path and the second flow path are connected via a cavity simulating a lesion site of the human body, a shunt portion, and a plurality of simulated side branches.

### CROSS-REFERENCES TO RELATED APPLICATIONS

This application is a continuation of International Application No. PCT/JP2023/019849 filed on May 29, 2023, which claims priority to Japanese Application No. 2022-090793 filed on Jun. 3, 2022, the entire content of both of which is incorporated herein by reference.

### TECHNOLOGICAL FIELD

The present disclosure generally relates to a procedure simulator used for education for a procedure using a catheter.

### BACKGROUND DISCUSSION

Various procedure simulators have been proposed as procedure education tools for doctors who will perform a catheter procedure (for example, Japanese Patent Application Publication No. 2021-071501 A).

However, there is a problem that there are not enough educational tools for catheter procedures for rare diseases, and there are few opportunities for inexperienced doctors to gain experience of catheter procedures for rare diseases. Therefore, it is required to provide more doctors with an opportunity to promote understanding of rare diseases and to teach treatment techniques of the rare diseases.

### SUMMARY

An aspect of the following disclosure is a procedure simulator for training a procedure using a catheter, the procedure simulator including a first flow path member that forms a first flow path simulating a vena cava of a human body; and a second flow path member that forms a second flow path simulating a second venous system of the human body independent of the vena cava, in which the second flow path member includes a cavity that communicates with the second flow path and simulates a lesion site of the human body, a shunt portion that causes the cavity and the first flow path to communicate with each other and connects the second flow path member and the first flow path member, and one or a plurality of simulated side branches that are independent of the shunt portion and communicate the cavity and the first flow path with a flow path cross-sectional area narrower than a flow path cross-sectional area of the shunt portion, and liquid flows through the second flow path at a pressure higher than a pressure of the first flow path.

In accordance with another aspect, a procedure simulator for training a procedure using a catheter, the procedure simulator comprising: a first flow path member that forms a first flow path; a second flow path member that forms a second flow path, the second flow path member including: a cavity that communicates with the second flow path, a shunt portion that causes the cavity and the first flow path to communicate with each other and connects the second flow path member and the first flow path member, and one or a plurality of side branches that are independent of the shunt portion and communicate the cavity and the first flow path with a flow path cross-sectional area narrower than a flow path cross-sectional area of the shunt portion; and wherein liquid flows through the second flow path at a pressure higher than a pressure of the first flow path.

In accordance with a further aspect, a simulation method for training a procedure using a catheter, the method comprising: simulating a first venous system of the human body with a first flow path member that forms a first flow path, the first venous system being a vena cava of the human body; simulating a second venous system of the human body independent of the vena cava with a second flow path member that forms a second flow path, wherein the second flow path member includes a cavity that communicates with the second flow path and simulates a lesion site of the human body, a shunt portion that causes the cavity and the first flow path to communicate with each other and connects the second flow path member and the first flow path member, and one or a plurality of simulated side branches that are independent of the shunt portion and communicate the cavity and the first flow path with a flow path cross-sectional area narrower than a flow path cross-sectional area of the shunt portion; and flowing liquid through the second flow path at a pressure higher than a pressure of the first flow path.

According to the procedure simulator from the above viewpoint, it is possible to promote understanding of rare diseases such as aneurysms caused by reflux in the second venous system to a larger number of doctors, and provide an opportunity to teach treatment techniques for the rare diseases.

### BRIEF DESCRIPTION OF THE DRAWINGS

FIG. 1A is an explanatory view illustrating a blood flow in a portal vein in a normal state.

FIG. 1B is an explanatory view illustrating a blood flow in a portal vein at the time of onset of gastric varices as an example of a rare disease.

FIG. 2 is a configuration diagram of a procedure simulator according to a first embodiment.

FIG. 3 is a plan view of a main part of a blood vessel model of the procedure simulator of FIG. 2.

FIG. 4 is a schematic view illustrating a flow path connection structure of the blood vessel model of FIG. 3.

FIG. 5 is an explanatory view illustrating an insertion path of a balloon catheter in training of a varicose vein treatment method using a gastrorenal shunt (shunt portion).

FIG. 6 is an explanatory view illustrating a visualization example of occlusion of gastric varices by a balloon and gastric varices using a coloring agent simulating a contrast medium.

FIG. 7 is an explanatory view illustrating a visualization example of gastric varices in a state where a balloon is inflated on the upstream side of FIG. 6 to occlude a simulated side branch.

FIG. 8 is an explanatory view of a procedure simulator according to a second embodiment.

FIG. 9 is a perspective view of a pump module of FIG. 8.

### DETAILED DESCRIPTION

Set forth below with reference to the accompanying drawings is a detailed description of embodiments of a procedure simulator used for education for a procedure using a catheter.

Prior to the description of embodiments, gastric varices caused by abnormality of a portal vein (second venous system) will be described.

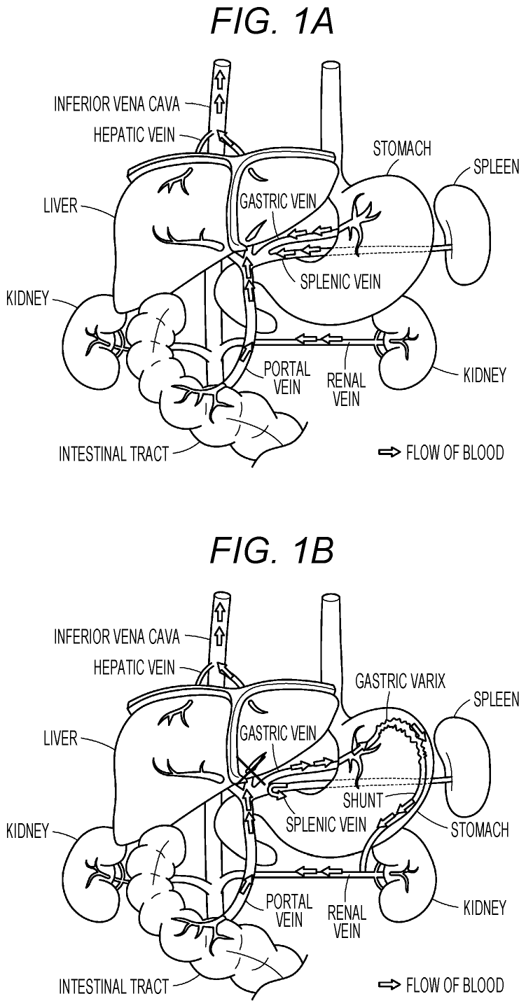

As illustrated in FIG. 1A, the portal vein is a vein that enters the liver from abdominal organs such as the stomach, small intestine, large intestine, pancreas, and spleen. The portal vein includes the superior mesenteric vein, inferior mesenteric vein, splenic vein, gastric vein. The venous blood that has absorbed nutrients in the intestines and the like is collected by the portal vein and sent to the liver. The liver removes harmful components from the blood flowing from the portal vein, and supplies the blood to the vena cava. In normal states, a blood flow in the superior mesenteric vein, inferior mesenteric vein, splenic vein, and gastric vein is antegrade, and flows toward the liver as illustrated in the drawing.

For example, when liver cirrhosis or the like occurs, the amount of blood that can flow into the liver from the portal vein may be decreased. In this case, the pressure of the portal vein is increased to develop portal hypertension. As illustrated in FIG. 1B, in a state where the portal hypertension has occurred, the blood flow in some blood vessels such as the gastric vein becomes retrograde, and venous blood flows into the gastric vein. As a result, a large amount of blood flows into the gastric vein, which may cause gastric varices swollen in a hump shape toward the inside of the stomach. In the gastric varices, a shunt (gastrorenal shunt) is formed between the gastric varices and the adjacent renal veins. The gastric varices can rupture and cause major bleeding. In addition, when the shunt develops, most of blood in the portal vein flows out to the vena cava without passing through the liver, and thus blood ammonia is increased, and consciousness disorder such as hepatic encephalopathy may be caused.

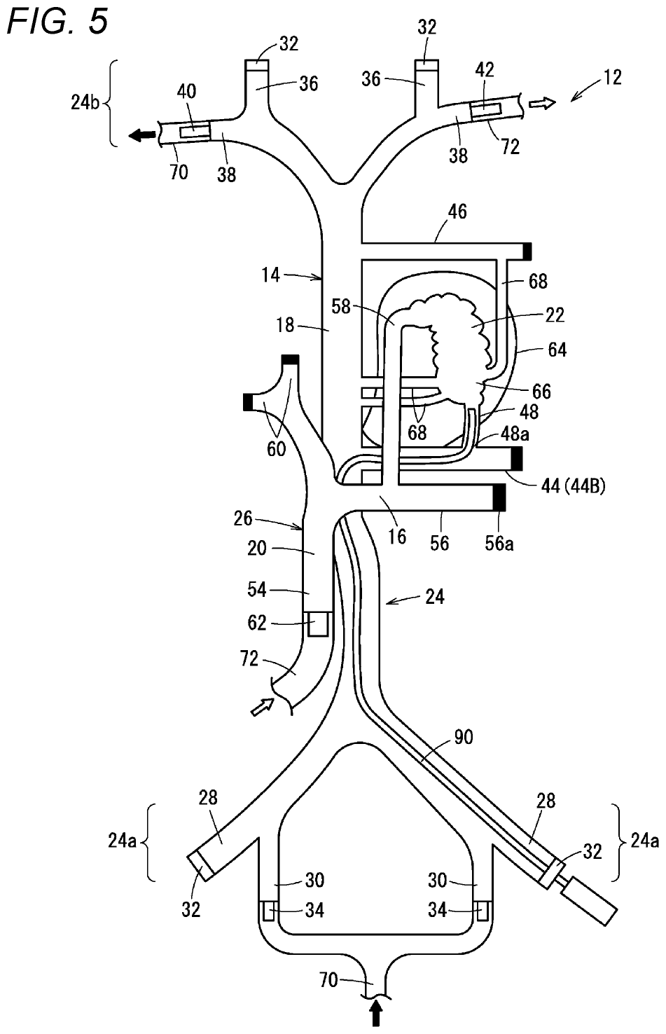

As one of treatment methods for such gastric varices, there is balloon-occluded retrograde transvenous obliteration (B-RTO). In the B-RTO, a balloon catheter 90 (refer to FIG. 5) is inserted from the femoral vein or the like, and the distal end of the balloon catheter 90 is disposed inside the shunt or the gastric varices from an outlet side of the shunt via the vena cava. Then, in a state where a balloon 92 is inflated to block the blood flow of the gastric varices, a contrast medium is injected to visualize the gastric varices. In a case where the gastric varices are not visualized, there is a possibility that collateral circulation is formed. In the presence of the collateral circulation, even when an embolic agent is injected into the gastric varices, the embolic agent leaks through the collateral circulation. For this reason, before the embolization of gastric varices, it is necessary to find and embolize the collateral circulation in advance. In a case where the collateral circulation is identified and embolized and the outflow of the contrast medium from gastric varices is no longer observed, an embolic agent is injected to the inside of the gastric varices to occlude the gastric varices.

Since the number of cases of such gastric varices is small, experienced doctors often take charge of treatment, and there are few opportunities for young doctors to perform treatment. Therefore, in the following embodiments, a procedure simulator 10 that enables a doctor with little treatment experience to promote understanding of gastric varices and accumulate treatment experience will be described.

### First Embodiment

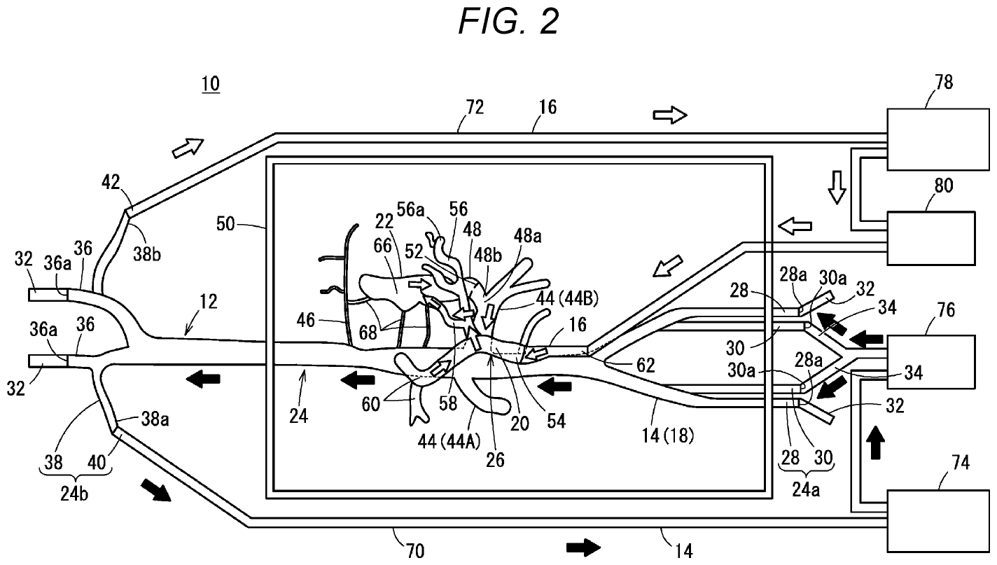

As illustrated in FIG. 2, the procedure simulator 10 according to the present embodiment includes a blood vessel model 12, a first circulation circuit 14, and a second circulation circuit 16. The blood vessel model 12 includes a first flow path 18 simulating the vena cava of the human body and a second flow path 20 simulating the portal vein of the human body. The first flow path 18 and the second flow path 20 are connected to each other via a simulated lesion site 22 simulating a gastric varix as a lesion site. The first circulation circuit 14 is a circulation circuit that causes a liquid (for example, water) simulating blood to flow through the first flow path 18, and the second circulation circuit 16 is a circulation circuit that causes liquid (water) simulating blood to flow through the second flow path 20.

The procedure simulator 10 of the present embodiment can learn the procedure by inserting the balloon catheter 90 in a state where the liquid actually flows through the blood vessel model 12 through the first circulation circuit 14 and the second circulation circuit 16. In addition, by pouring a coloring agent simulating a contrast medium into the blood vessel model 12 from the distal end of the balloon catheter 90, it is possible to visually understand a change in the flow of blood in the blood vessel. Hereinafter, details of each unit will be further described.

The blood vessel model 12 includes a first flow path member 24 and a second flow path member 26. The first flow path member 24 is a member that forms the first flow path 18. The first flow path member 24 has a lower limb side end portion 24a and an upper limb side end portion 24b. The first flow path 18 constitutes a flow path through which liquid flows with the lower limb side end portion 24a as an upstream side and the upper limb side end portion 24b as a downstream side. The first flow path 18 branches into two, simulating the iliac vein of the human body on the lower limb side. Furthermore, each of the branched portions has a third flow path 28 simulating the femoral vein and a fourth flow path 30 simulating the large saphenous vein on the upstream side (lower limb side) of the large saphenous vein.

The first flow path member 24 has a catheter port 32 for inserting the balloon catheter 90, at an end portion 28a (lower limb side end portion 24a) on the upstream side of each of the two third flow paths 28. In addition, the first flow path member 24 has a first inflow port 34 for introducing liquid (for example, water) simulating blood, at an end portion 30a (lower limb side end portion 24a) on the upstream side of each of the two fourth flow paths 30.

The first flow path 18 branches into two, simulating the brachiocephalic vein, on the upper limb side. The first flow path 18 includes a fifth flow path 36 and a sixth flow path 38 on the downstream side (upper limb side) of each of the portions simulating the brachiocephalic vein. The fifth flow path 36 is a flow path simulating the internal jugular vein, and the sixth flow path 38 is a flow path simulating the subclavian vein. The first flow path member 24 has the catheter port 32 at an end portion 36a on the downstream side (head and neck side) of each of the two fifth flow paths 36. In addition, the first flow path member 24 has a first outflow port 40 that allows liquid to flow out to an end portion 38a on the downstream side of one of the sixth flow paths 38, and has a second outflow port 42 that allows liquid to flow out to an end portion 38b on the downstream side of the other sixth flow path 38.

The first flow path 18 further includes a simulated renal vein 44 near the central portion between the upper limb side end portion 24b and the lower limb side end portion 24a. The simulated renal vein 44 is a flow path simulating the renal vein of the human body. The procedure simulator 10 of the present embodiment includes a first simulated renal vein 44A simulating the right renal vein going toward the right kidney and a second simulated renal vein 44B simulating the left renal vein going toward the left kidney. The distal end of the first simulated renal vein 44A is occluded. The second simulated renal vein 44B is connected to a shunt portion 48. The second simulated renal vein 44B communicates with the second flow path 20 of the second flow path member 26 via the shunt portion 48. That is, the shunt portion 48 is formed to be connected to the first flow path 18 (simulated renal vein 44) and the second flow path 20 (simulated gastric vein 58).

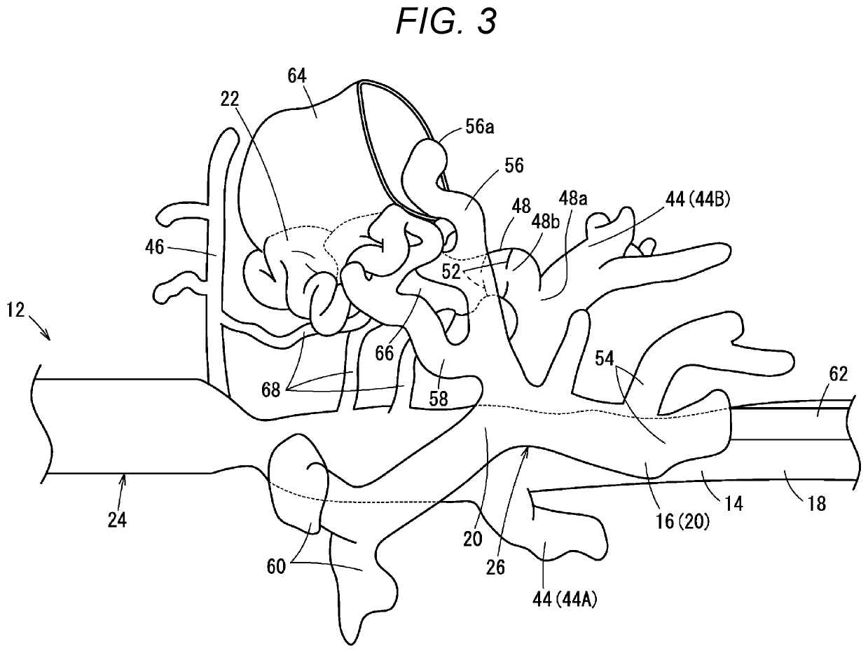

The first flow path 18 includes a seventh flow path 46 branching and extending laterally, at a position spaced apart on the upper limb side of the simulated renal vein 44. The cross-sectional area of the flow path lumen of the seventh flow path 46 is narrower than that of the simulated renal vein 44. The seventh flow path 46 extends toward the left side of the simulated stomach 64 (refer to FIG. 3), that is, toward the right side when viewed from above a holding case 50 when the blood vessel model 12 of FIG. 2 is disposed with the lower limb side end portion 24a on the lower side and the upper limb side end portion 24b on the upper side in the holding case 50. A simulated side branch 68 branches from the seventh flow path 46.

Furthermore, the shunt portion 48 or a connection portion 48a between the shunt portion 48 and the simulated renal vein 44 has a simulated venous valve 52 that simulates a venous valve. The simulated venous valve 52 is a membrane-like member protruding inward from an inner peripheral wall of the flow path. The simulated venous valve 52 is opened to an extent that the lumen of the flow path is not completely occluded. Alternatively, instead of separately providing a membrane member, the lumen may be formed to be narrowed only at a portion corresponding to the simulated venous valve 52. A plurality of simulated venous valves 52 may be provided, and in the present embodiment, three simulated venous valves 52 are provided from the shunt portion 48 to the connection portion 48a. The simulated venous valve 52 provides a feeling that the distal end of the balloon catheter 90 is caught when the balloon catheter 90 is advanced. The simulated venous valve 52 moderately increases a difficulty level of a catheter operation to promote improvement of the catheter operation skill of a user. In addition, the simulated venous valve 52 may be appropriately disposed in the first flow path member 24.

As illustrated in FIG. 3, the second flow path member 26 is a member forming the second flow path 20. The second flow path 20 is a flow path simulating the portal vein of the human body. In the holding case 50 of the procedure simulator 10, the second flow path member 26 is disposed on the front side of the first flow path member 24. The second flow path 20 includes a simulated mesenteric vein 54 that simulates the superior mesenteric vein and the inferior mesenteric vein, a simulated splenic vein 56 that simulates the splenic vein, the simulated gastric vein 58 that simulates the gastric vein, and a liver-side end portion 60 that simulates a portion toward the liver.

In the second flow path member 26, the spleen, the intestine, and the liver are omitted, and the simulated mesenteric vein 54, the simulated splenic vein 56, and the liver-side end portion 60 directed to the spleen, the intestine, and the liver are reproduced in a halfway range (i.e., only a portion of the simulated mesenteric vein 54, the simulated splenic vein 56, and the liver-side end portion 60 are reproduced). The second flow path member 26 has a second inflow port 62 in the simulated mesenteric vein 54. The second inflow port 62 is a port for introducing liquid (water) simulating blood into the second flow path 20. In the second flow path 20, the liver-side end portion 60 is completely occluded to simulate the portal hypertension. In addition, an end portion 56a of the simulated splenic vein 56 is also occluded to reproduce retrograde blood flow in the simulated gastric vein 58.

The second flow path member 26 further includes the simulated stomach 64 that simulates a part of the stomach, the simulated lesion site 22 that simulates the gastric varix, and the shunt portion 48. The simulated stomach 64 includes only the stomach and a part near the lower esophagus, and the pyloric portion of the simulated stomach 64 is cut and omitted. Through the cut opening portion, the simulated lesion site 22 (gastric varix) bulging inside the simulated stomach 64 can be visually recognized. The outer surface of the simulated lesion site 22 is formed to bulge into the lumen of the simulated stomach 64 along the inner surface of the simulated stomach 64.

A cavity 66 is formed inside the simulated lesion site 22. One end of the simulated gastric vein 58 communicates with one end of the cavity 66. The shunt portion 48 is disposed to be connected to the lower limb side of the simulated lesion site 22. The shunt portion 48 is located on the dorsal side of the simulated splenic vein 56. The shunt portion 48 communicates with the cavity 66 and communicates with the simulated renal vein 44. The shunt portion 48 forms a flow path having a relatively large cross section similar to that of the cavity 66, and constitutes a flow path for causing the simulated gastric vein 58 and the simulated renal vein 44 to communicate with each other.

The shunt portion 48 has a curved portion 48b in which a center line of the flow path is largely curved in an arc shape or a semicircular shape, in the vicinity of the connection portion 48a with the simulated renal vein 44. Such a curved portion 48b requests a practitioner to perform an operation of greatly bending the balloon catheter 90. The procedure simulator 10 of the present embodiment can promote the improvement of the skill of the doctor by reproducing such a curved portion 48b in the shunt portion 48, and is effective for shortening the time required for the procedure.

In addition, the blood vessel model 12 includes a plurality of simulated side branches 68 that simulate a collateral circulation connecting the simulated lesion site 22 of the second flow path member 26 and the first flow path member 24. These simulated side branches 68 have a flow path cross-sectional area narrower than the shunt portion 48. These simulated side branches 68 connect the cavity 66 and the first flow path 18. Some simulated side branches 68 communicate with the first flow path 18 via the seventh flow path 46. Some simulated side branches 68 may connect to the cavity 66 on the dorsal side of the simulated lesion site 22. The provision of such a simulated side branch 68 serves as training for visual recognition of a connection position between the cavity 66 and the simulated side branch 68 and for determination of the position to inflate the balloon 92 of the balloon catheter 90, which leads to improvement of the technique of occlusion of the lesion site by the balloon 92.

The blood vessel model 12 as described above can be integrally formed of, for example, a transparent resin having elasticity such as silicone elastomer. The blood vessel model 12 can be manufactured by, for example, a 3D printer or the like.

As illustrated in FIG. 2, the blood vessel model 12 may be held in the water-tub holding case 50. The first circulation circuit 14 and the second circulation circuit 16 are connected to the blood vessel model 12. The first circulation circuit 14 is a circulation flow path including a first return flow path 70 and the first flow path 18. The first return flow path 70 is a flow path connecting the first outflow port 40 and the first inflow port 34 of the first flow path member 24. The first return flow path 70 includes a first storage tank 74 and a first pump 76 on the way. The first pump 76 delivers liquid (water) to the first inflow port 34. The first storage tank 74 is connected between the first outflow port 40 and the first pump 76. The first outflow port 40 and the first storage tank 74, the first storage tank 74 and the first pump 76, and the first pump 76 and the first inflow port 34 are connected by a flexible tube.

The second circulation circuit 16 is a circulation flow path including a second return flow path 72, the second flow path 20, and a part of the first flow path 18. The second return flow path 72 is a flow path connecting the second outflow port 42 and the second inflow port 62. The second return flow path 72 includes a second storage tank 78 and a second pump 80 on the way. The second pump 80 is connected to the second inflow port 62, and delivers liquid (water) toward the second inflow port 62.

The second pump 80 delivers liquid at a higher flow rate than the first pump 76. The second storage tank 78 is connected between the second pump 80 and the second outflow port 42. The liquid level of the second storage tank 78 is disposed at a position higher than the liquid level of the first storage tank 74. A pressure corresponding to the difference between the liquid level positions of the first storage tank 74 and the second storage tank 78 is applied to the liquid flowing through the second flow path 20. The second flow path 20 is maintained at a higher pressure than the first flow path 18 by the flow rate of the second pump 80 and the pressure from the second storage tank 78.

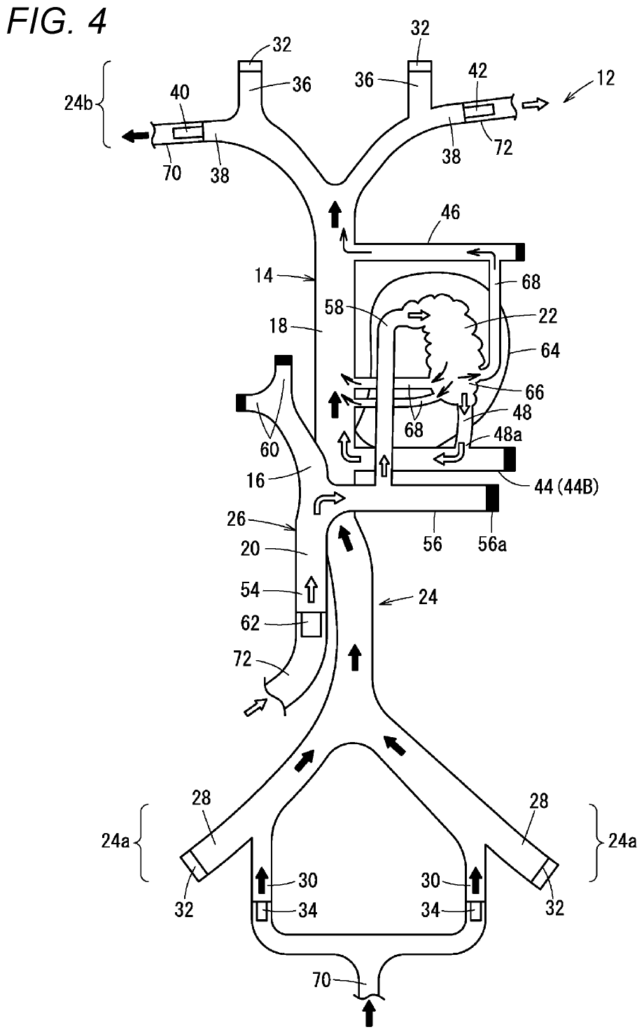

The procedure simulator 10 according to the present embodiment is configured as described above. Next, the flow of the fluid inside the blood vessel model 12 will be described with reference to FIG. 4.

As illustrated in FIG. 4, liquid flows into the first flow path member 24 through the first inflow port 34 of the fourth flow path 30. The fluid flowing in from the two first inflow ports 34 flows toward the upper limb side end portion 24b of the first flow path 18. First fluid joins second fluid in the second flow path 20 at a joint portion of the first flow path 18 with the second simulated renal vein 44B, and further flows toward the upper limb side end portion 24b. The fluid in the first flow path 18 flows out from the first outflow port 40 and the second outflow port 42. The fluid flowing out from the first outflow port 40 flows through the first return flow path 70 and flows into the first inflow port 34. The fluid flowing out from the second outflow port 42 flows to the second return flow path 72.

The fluid flows into the second flow path member 26 from the second inflow port 62. Since a portion other than the simulated gastric vein 58 is occluded, the second flow path 20 flows retrograde through the simulated gastric vein 58 toward the stomach. The fluid flows into the cavity 66 of the simulated lesion site 22 via the simulated gastric vein 58. Most of the fluid flowing into the cavity 66 flows from the shunt portion 48 having a flow path cross-sectional area larger than the simulated side branch 68, toward the second simulated renal vein 44B. Then, the fluid flowing in from the second inflow port 62 joins the fluid flowing in from the first inflow port 34 through the second simulated renal vein 44B. In addition, part of the fluid in the cavity 66 flows from the plurality of simulated side branches 68 toward the first flow path 18. Since the pressure in the second flow path 20 is higher than the pressure in the first flow path 18, the fluid in the second flow path 20 flows toward the first flow path 18, and the flow in the retrograde direction does not occur (i.e., flow from the first flow path 18 towards the second flow path 20 does not occur). Such the flow of the fluid is similar to the state where the portal hypertension has occurred, and the procedure simulator 10 can reproduce the blood flow of the portal hypertension.

The procedure simulator 10 described above can be used as follows.

As illustrated in FIG. 5, the balloon catheter 90 is introduced into the first flow path 18 from any of the four catheter ports 32. In the illustrated example, the balloon catheter 90 is introduced from the catheter port 32 of the third flow path 28 simulating the femoral vein. The balloon catheter 90 is advanced toward the upper limb side inside the first flow path 18, and is inserted into the second simulated renal vein 44B. Further, the balloon catheter 90 is advanced from the shunt portion 48 toward the cavity 66.

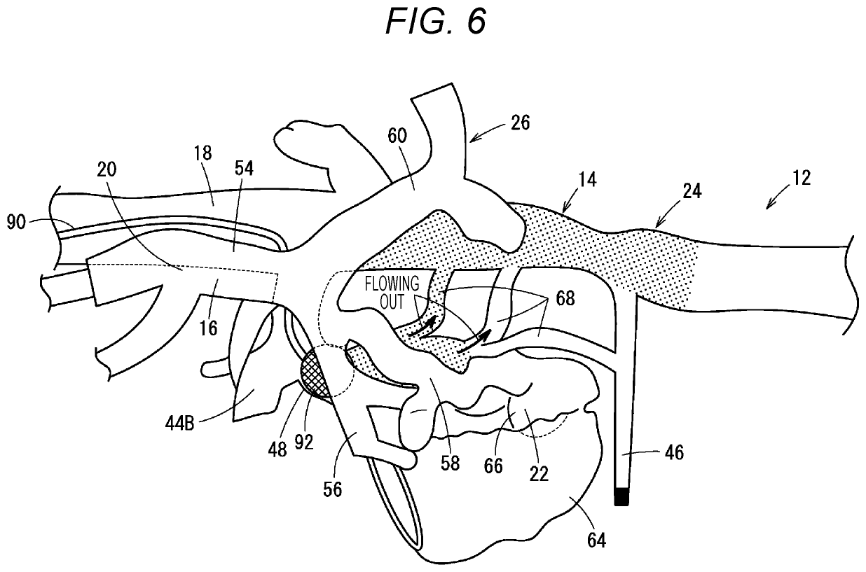

As illustrated in FIG. 6, the inflation operation of the balloon 92 is performed inside the shunt portion 48, and the outlet of the shunt portion 48 is occluded by the balloon 92. Thereafter, a coloring agent used as a contrast medium is injected from the distal end of the balloon catheter 90. Since the blood vessel model 12 is formed of a transparent material, the coloring agent can be visually recognized from the outside. In order to inject an embolic agent into the cavity 66 of the simulated lesion site 22 for treatment, it is necessary (1) to occlude the shunt portion 48 by disposing the balloon 92 at an appropriate position and inflating the balloon 92, and (2) that the blood flow in a drainage route such as the simulated side branch 68 is absent or blocked. In a case where these are appropriately performed, the entire cavity 66 is visualized by the coloring agent. In the illustrated example, the position of the balloon 92 is the downstream side of the simulated side branch 68. Therefore, the balloon 92 does not occlude the simulated side branch 68 positioned on the upstream side, and most of the liquid flowing into the cavity 66 flows out from the simulated side branch 68. Therefore, the contrast medium injected from the distal end of the balloon 92 flows out through the simulated side branch 68 along with the flow of the liquid, and only a part of the cavity 66 is visualized.

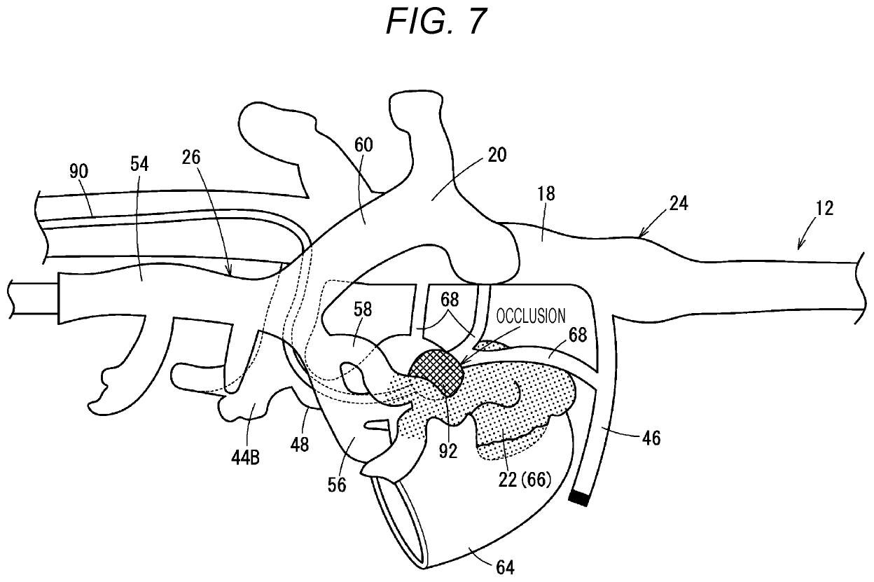

In such a case, before injecting the embolic agent into the cavity 66, as illustrated in FIG. 7, the position of the simulated side branch 68 is specified, and an operation of filling the simulated side branch 68 with a coil to occlude the simulated side branch 68, an operation of changing the position where the balloon 92 is to be inflated, or the like is performed. In the illustrated example, the position of the balloon 92 is the upstream side of all simulated side branches 68. With this operation, the outflow of liquid from the cavity 66 through the simulated side branch 68 is prevented, and the entire cavity 66 is visualized by the contrast medium. In addition, in a case where the blood discharge from the simulated side branch 68 is observed even when the position where the balloon 92 is inflated is changed, it can be determined that embolization of the simulated side branch 68 is necessary. Thus, the training of the B-RTO using the procedure simulator 10 is completed. According to the procedure simulator 10, the user can gain experience in approaching the shunt portion 48 using the balloon catheter 90 and coping with the outflow of the contrast medium by the simulated side branch 68. Note that a configuration may be employed in which the simulated side branch 68 can be occluded or released by providing a clamp or the like at an arbitrary position of the simulated side branch 68.

### Second Embodiment

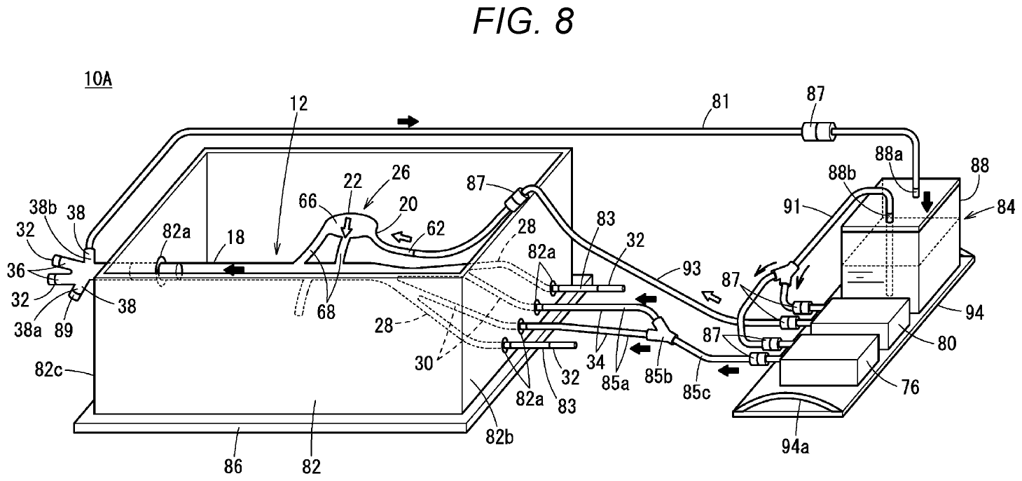

As illustrated in FIG. 8, a procedure simulator 10A of the present embodiment further includes a water-tub holding case 82, a storage tank 88, a pump module 84, and a light projection plate 86. In the configuration of the procedure simulator 10A in FIG. 8, the same components as those of the procedure simulator 10 described with reference to FIGS. 2 to 7 are denoted by the same reference numerals, and a detailed description of those same components will be omitted.

The holding case 82 can be formed of a box-shaped container. The holding case 82 is formed of transparent resin or glass. The holding case 82 accommodates the blood vessel model 12 in the holding case 82. The blood vessel model 12 can be formed of, for example, a flexible and transparent silicone elastomer, and has the same structure as the blood vessel model 12 described with reference to FIGS. 2 and 3. Although the method of use is not particularly limited, the holding case 82 can store water for use. Water is close to the refractive index of the transparent silicone elastomer forming the blood vessel model 12. Therefore, in a case where water is stored in the holding case 82 and the blood vessel model 12 is disposed in the water, the appearance of the blood vessel model 12 is close to the blood vessel imaged in the X-ray fluoroscopic image.

The holding case 82 has a connection portion 82a at a predetermined position. The connection portion 82a is provided to penetrate a side wall of the holding case 82. The connection portion 82a is a joint for connecting a tube or the like to the flow path of the blood vessel model 12 without leaking water. Five connection portions 82a are provided. Four connection portions 82a are provided at one end portion 82b of the holding case 82 in the longitudinal direction, and one connection portion 82a is provided at the other end portion 82c of the holding case 82 in the longitudinal direction. Two third flow paths 28 and two fourth flow paths 30 of the blood vessel model 12 are respectively connected to inner portions of the four connection portions 82a of the one end portion 82b. A tube 83 is connected to an outer portion of each of the two connection portions 82a connected to the third flow path 28.

The catheter port 32 is provided at each end portion of the tube 83. The first inflow port 34 is connected to each of the outer portions of the two connection portions 82a connected to the fourth flow path 30. The first inflow port 34 is formed of a tube 85a. The two tubes 85a are connected to one common tube 85c via a Y-joint 85b. The common tube 85c is connected to the first pump 76 via a one-touch connector 87. The one-touch connector 87 is a connector that can connect or disconnect a male-side connector and a female-side connector by operating an operation member such as a lever or a button.

Although not particularly limited, in the present embodiment, a part of the downstream side of the blood vessel model 12 is divided by the other end portion 82c of the holding case 82. The divided portions of the blood vessel model 12 may be connected to each other via the connection portion 82a disposed to penetrate an opening provided at the other end portion 82c of the holding case 82. That is, a part of the downstream side of the blood vessel model 12 extends to the outside of the holding case 82, and is connected to a part of the upstream side of the blood vessel model 12 via the connection portion 82a.

The first flow path 18 on the downstream side of the blood vessel model 12 branches into two fifth flow paths 36 and two sixth flow paths 38. The catheter port 32 is provided in each of the two fifth flow paths 36. The end portion 38a of one of the sixth flow paths 38 is attached with a valve connector 89 and is occluded by the valve connector 89. The valve connector 89 also functions as a catheter port into which a catheter or the like is inserted as necessary. A tube 81 is connected to the end portion 38b of the other sixth flow path 38. The tube 81 connects the end portion 38b of the blood vessel model 12 and the storage tank 88. The tube 81 has the one-touch connector 87 in the middle, and can be separated into a portion on the holding case 82 side and a portion on the storage tank 88 side.

In the present embodiment, the tube 81 serves as a circulation path of a first venous system (vena cava) and a circulation path of a second venous system. That is, the liquid discharged from the downstream side of the blood vessel model 12 is returned to the storage tank 88 only through the tube 81.

The storage tank 88 stores liquid (water) flowing through the first flow path 18 and the second flow path 20 of the blood vessel model 12. The storage tank 88 simplifies the structure of the procedure simulator 10A by integrating the first storage tank 74 and the second storage tank 78 in FIG. 2. The storage tank 88 has an inflow port 88a and an outflow port 88b. The tube 81 is connected to the inflow port 88a. The liquid discharged from the blood vessel model 12 flows into the storage tank 88 from the inflow port 88a. A tube 91 is connected to the outflow port 88b. The tube 91 branches into two on the downstream side, one of which is connected to the first pump 76 and the other is connected to the second pump 80. The tube 91 guides the liquid in the storage tank 88 to the first pump 76 and the second pump 80.

The first pump 76 and the second pump 80 are similar to the first pump 76 and the second pump 80 described with reference to FIG. 2. The first pump 76 supplies liquid to the first flow path 18, and the second pump 80 supplies liquid to the second flow path 20. The first pump 76 and the second pump 80 generate a pressure difference between the first flow path 18 and the second flow path 20 by adjusting their power. The second pump 80 is connected to the second flow path member 26 (second flow path 20) via a tube 93. The one-touch connector 87 is attached in the middle of the tube 93, and allows the holding case 82 side and the second pump 80 side to be separated or connected.

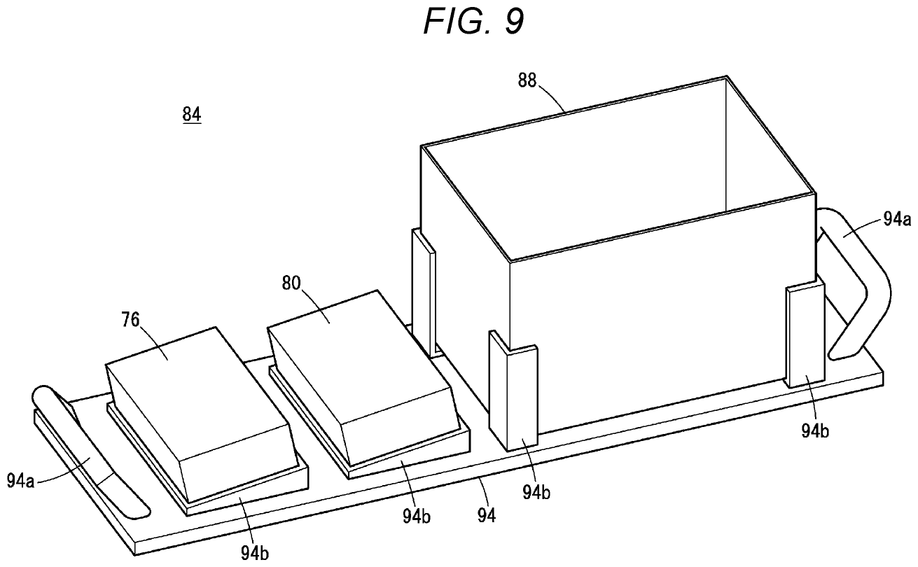

As illustrated in FIG. 9, the storage tank 88, the first pump 76, and the second pump 80 are integrated as the pump module 84. The pump module 84 includes a plate 94. The plate 94 is an elongated rectangular flat plate. The plate 94 has gripping portions 94a at one end and the other end in the longitudinal direction. On the upper surface of the plate 94, a holding frame 94b for fixing the storage tank 88, the first pump 76, and the second pump 80 is provided. The procedure simulator 10A is excellent in portability since the storage tank 88, the first pump 76, and the second pump 80 are integrated as the pump module 84.

The light projection plate 86 is disposed below the holding case 82. The light projection plate 86 is a planar light emitting member, and illuminates the blood vessel model 12 with uniform luminance from the lower side of the holding case 82. When the blood vessel model 12 is illuminated by the light projection plate 86, an image captured by an X-ray fluoroscopic device is generated by the light transmitted through the blood vessel model 12. Note that the light projection plate 86 is used as necessary, and is not essential to the procedure simulator 10A.

As illustrated in FIG. 8, in the procedure simulator 10A as described above, constituent members are integrated into the holding case 82 and the pump module 84. Therefore, the procedure simulator 10A can be carried separately as the holding case 82 and the pump module 84, and is excellent in handleability. In addition, the tubes connecting the holding case 82 and the pump module 84 can be separated by the one-touch connector 87. The one-touch connector 87 enables connection and separation between the holding case 82 and the pump module 84 without bothersome attachment and detachment of tubes, and thus simplifies a preparation work before use.

The above disclosure is summarized as follows.
(1) A procedure simulator (10, 10A) for training a procedure using a catheter (90), the procedure simulator (10, 10A) including: a first flow path member (24) that forms a first flow path (18) simulating a vena cava of a human body; and a second flow path member (26) that forms a second flow path (20) simulating a second venous system of the human body independent of the vena cava, wherein the second flow path member includes a cavity (66) that communicates with the second flow path and simulates a lesion site of the human body, a shunt portion (48) that causes the cavity and the first flow path to communicate with each other and connects the second flow path member and the first flow path member, and one or a plurality of simulated side branches (68) that are independent of the shunt portion and communicate the cavity and the first flow path with a flow path cross-sectional area narrower than a flow path cross-sectional area of the shunt portion, and liquid flows through the second flow path at a pressure higher than a pressure of the first flow path.

The above-described procedure simulator can reproduce the flow of blood at the lesion site accompanying the increase in the pressure of the second venous system by allowing the liquid simulating the blood to flow through the first flow path and the second flow path. As a result, it is possible to practice the procedure while understanding the change in the flow of blood at the lesion site during the procedure on the lesion site using the catheter.
(2) In the procedure simulator according to (1), the second flow path of the second flow path member may have a shape simulating a portal vein of the human body, and the cavity may have a shape simulating a gastric varix. This procedure simulator is suitable for practice of a treatment procedure for gastric varices due to the portal hypertension.
(3) In the procedure simulator according to (2), the first flow path may include a simulated renal vein (44) that branches from a portion simulating the vena cava and simulates a renal vein of the human body, the second flow path may include a simulated gastric vein (58) that branches from the portal vein and simulates the gastric vein of the human body, the first flow path may communicate with the shunt portion via the simulated renal vein, and the second flow path may communicate with the cavity via the simulated gastric vein. This procedure simulator is suitable for practice of a procedure of approaching the shunt portion from the simulated renal vein.
(4) In the procedure simulator according to any one of (1) to (3), the first flow path member may have a simulated venous valve (52) that protrudes inward from an inner peripheral wall of the first flow path and is opened to an extent that a lumen of the first flow path is not completely occluded. Since this procedure simulator has a trouble in advancing the balloon catheter, the difficulty level of the catheter operation can be increased, and the effect of practice can be further enhanced. In addition, by forming the simulated venous valve to have a shape opened to an extent that the lumen of the first flow path is not completely occluded, it is possible to reproduce the feeling of the catheter transmitted to the operator at the time of treatment of the portal hypertension.
(5) In the procedure simulator according to any one of (1) to (3), the simulated side branch may be optionally occluded and released at an arbitrary position of the simulated side branch. This procedure simulator can adjust the difficulty level in accordance with the skill level of the operator by occluding the simulated side branch with a clamp or the like.
(6) In the procedure simulator according to (3), the shunt portion may have a curved portion (48b) in which a flow path center line is curved in an arc shape, in the vicinity of a joint portion with the simulated renal vein. This procedure simulator can effectively perform practice on the curvature of the shunt portion that is easy to take time to operate the catheter.
(7) In the procedure simulator according to any one of (1) to (4), the second flow path member may be disposed on a front side of the first flow path member, and the simulated side branch may be disposed at a position overlapping the second flow path member when the first flow path member and the second flow path member are viewed from the front side. This procedure simulator can be used to practice a response in a case where there is a simulated side branch at a position that is difficult to visually recognize from the front surface.
(8) In the procedure simulator according to any one of (1) to (4), the first flow path member and the second flow path member may be formed of a transparent elastic material. This procedure simulator can directly visually recognize the change in color of the liquid inside due to the coloring agent, and can easily understand the change in the flow of the liquid and the propriety of the inflation position of the balloon. As a result, training can be performed without performing fluoroscopy by X-rays.
(9) In the procedure simulator according to any one of (1) to (4), the second flow path member may have a second inflow port (62) through which the liquid simulating blood is introduced to the second flow path, at an end portion (54) of a portion simulating a mesenteric vein, and in the second flow path, a portion other than a simulated gastric vein, which is connected to the second inflow port and the cavity, may be occluded in advance. This procedure simulator can reproduce retrograde blood flow in the simulated gastric vein.
(10) In the procedure simulator according to (9), the first flow path member may have a first inflow port (34) that is provided in a lower limb side end portion (24a) and is for introducing the liquid, a catheter port (32) that is provided in the lower limb side end portion and is for introducing a catheter to the first flow path, and a first outflow port (40) and a second outflow port (42) that are provided in an upper limb side end portion (24b) and allow the liquid of the first flow path to flow out. This procedure simulator can practice the approach to the shunt portion through the femoral vein or central vein.
(11) The procedure simulator according to (10) may further include a first return flow path (70) that connects the first inflow port and the first outflow port; a second return flow path (72) that connects the second outflow port and the second inflow port; a first pump (76) that is disposed in the middle of the first return flow path and delivers the liquid to the first inflow port; and a second pump (80) that is disposed in the middle of the second return flow path and delivers the liquid to the second inflow port. This procedure simulator can generate a pressure difference between the first flow path and the second flow path by having two pumps, and can suitably reproduce the flow of blood due to the portal hypertension.
(12) In the procedure simulator according to (11), a delivery pressure of the liquid by the second pump may be higher than a delivery pressure of the liquid by the first pump. This procedure simulator can reproduce the flow of blood due to the portal hypertension.
(13) The procedure simulator according to (11) or (12) may further include a first storage tank (74) that is disposed in the first return flow path between the first outflow port and the first pump; and a second storage tank (78) that is disposed in the second return flow path between the second outflow port and the second pump, in which the second storage tank is disposed at a position higher than a position of the first storage tank. In this procedure simulator, the retrograde blood flow can be stably reproduced, and a stable pressure difference can be maintained by the height difference between the first storage tank and the second storage tank.

Note that the present invention is not limited to the disclosure described above, and various configurations can be adopted without departing from the gist of the present invention. For example, by changing the shape of the cavity 66 of the procedure simulator 10, it is possible to simulate esophageal varices and to apply to practice of treatment of esophageal varices.

The detailed description above describes embodiments of a procedure simulator used for education for a procedure using a catheter. The invention is not limited, however, to the precise embodiments and variations described. Various changes, modifications and equivalents may occur to one skilled in the art without departing from the spirit and scope of the invention as defined in the accompanying claims. It is expressly intended that all such changes, modifications and equivalents which fall within the scope of the claims are embraced by the claims.

What is claimed is:

1. A procedure simulator for training a procedure using a catheter, the procedure simulator comprising:
a first flow path member that forms a first flow path simulating a first venous system of the human body, the first venous system being a vena cava of the human body;
a second flow path member that forms a second flow path simulating a second venous system of the human body independent of the vena cava, and wherein the second flow path member includes:
a cavity that communicates with the second flow path and simulates a lesion site of the human body,
a shunt portion that causes the cavity and the first flow path to communicate with each other and connects the second flow path member and the first flow path member, and
one or a plurality of simulated side branches that are independent of the shunt portion and communicate the cavity and the first flow path with a flow path cross-sectional area narrower than a flow path cross-sectional area of the shunt portion; and
liquid flows through the second flow path at a pressure higher than a pressure of the first flow path.

2. The procedure simulator according to claim 1, wherein
the second flow path of the second flow path member has a shape simulating a portal vein of the human body; and
the cavity has a shape simulating a gastric varix.

3. The procedure simulator according to claim 2, wherein
the first flow path includes a simulated renal vein that branches from a portion simulating the vena cava and simulates a renal vein of the human body;
the second flow path includes a simulated gastric vein that branches from the portal vein and simulates the gastric vein of the human body;
the first flow path communicates with the shunt portion via the simulated renal vein; and
the second flow path communicates with the cavity via the simulated gastric vein.

4. The procedure simulator according to claim 1, wherein the first flow path member has a simulated venous valve that protrudes inward from an inner peripheral wall of the first flow path and is opened to an extent that a lumen of the first flow path is not completely occluded.

5. The procedure simulator according to claim 1, wherein the simulated side branch is occludable.

6. The procedure simulator according to claim 3, wherein the shunt portion has a curved portion in which a flow path center line is curved in an arc shape, in the vicinity of a joint portion with the simulated renal vein.

7. The procedure simulator according to claim 1, wherein the second flow path member is disposed on a front side of the first flow path member, and the simulated side branch is disposed at a position overlapping the second flow path member when the first flow path member and the second flow path member are viewed from the front side.

8. The procedure simulator according to claim 1, wherein the first flow path member and the second flow path member are formed of a transparent elastic material.

9. The procedure simulator according to claim 1, wherein
the second flow path member has a second inflow port through which the liquid simulating blood is introduced to the second flow path, at an end portion of a portion simulating a mesenteric vein; and
in the second flow path, a portion other than a simulated gastric vein, which is connected to the second inflow port and the cavity, is occluded in advance.

10. The procedure simulator according to claim 9, wherein the first flow path member has
a first inflow port that is provided in a lower limb side end portion and is for introducing the liquid,
a catheter port that is provided in the lower limb side end portion and is for introducing a catheter to the first flow path, and
a first outflow port and a second outflow port that are provided in an upper limb side end portion and allow the liquid of the first flow path to flow out.

11. The procedure simulator according to claim 10, further comprising:
a first return flow path that connects the first inflow port and the first outflow port;
a second return flow path that connects the second outflow port and the second inflow port;
a first pump that is disposed in the middle of the first return flow path and delivers the liquid to the first inflow port; and
a second pump that is disposed in the middle of the second return flow path and delivers the liquid to the second inflow port.

12. The procedure simulator according to claim 11, wherein a delivery pressure of the liquid by the second pump is higher than a delivery pressure of the liquid by the first pump.

13. The procedure simulator according to claim 11, further comprising:
a first storage tank that is disposed in the first return flow path between the first outflow port and the first pump; and
a second storage tank that is disposed in the second return flow path between the second outflow port and the second pump, and wherein the second storage tank is disposed at a position higher than a position of the first storage tank.

14. A procedure simulator for training a procedure using a catheter, the procedure simulator comprising:
a first flow path member that forms a first flow path;
a second flow path member that forms a second flow path, the second flow path member including:
a cavity that communicates with the second flow path,
a shunt portion that causes the cavity and the first flow path to communicate with each other and connects the second flow path member and the first flow path member, and
one or a plurality of side branches that are independent of the shunt portion and communicate the cavity and the first flow path with a flow path cross-sectional area narrower than a flow path cross-sectional area of the shunt portion; and
wherein liquid flows through the second flow path at a pressure higher than a pressure of the first flow path.

15. The procedure simulator according to claim 14, wherein the first flow path member has a valve that protrudes inward from an inner peripheral wall of the first flow path and is opened to an extent that a lumen of the first flow path is not completely occluded.

16. The procedure simulator according to claim 14, wherein the second flow path member is disposed on a front side of the first flow path member, and the simulated side branch is disposed at a position overlapping the second flow path member when the first flow path member and the second flow path member are viewed from the front side.

17. The procedure simulator according to claim 14, wherein
the second flow path member has a second inflow port through which the liquid is introduced to the second flow path, and in the second flow path, a portion, which is connected to the second inflow port and the cavity, is occluded in advance; and
the first flow path member includes a first inflow port for introducing the liquid, a catheter port that is provided for introducing a catheter to the first flow path, and a first outflow port and a second outflow port that are provided to allow the liquid of the first flow path to flow out.

18. The procedure simulator according to claim 17, further comprising:
a first return flow path that connects the first inflow port and the first outflow port;
a second return flow path that connects the second outflow port and the second inflow port;
a first pump that is disposed in the middle of the first return flow path and delivers the liquid to the first inflow port; and
a second pump that is disposed in the middle of the second return flow path and delivers the liquid to the second inflow port, and wherein a delivery pressure of the liquid by the second pump is higher than a delivery pressure of the liquid by the first pump.

19. The procedure simulator according to claim 18, further comprising:
a first storage tank that is disposed in the first return flow path between the first outflow port and the first pump; and
a second storage tank that is disposed in the second return flow path between the second outflow port and the second pump, and wherein the second storage tank is disposed at a position higher than a position of the first storage tank.

20. A simulation method for training a procedure using a catheter, the method comprising:
simulating a first venous system of the human body with a first flow path member that forms a first flow path, the first venous system being a vena cava of the human body;
simulating a second venous system of the human body independent of the vena cava with a second flow path member that forms a second flow path, wherein the second flow path member includes a cavity that communicates with the second flow path and simulates a lesion site of the human body, a shunt portion that causes the cavity and the first flow path to communicate with each other and connects the second flow path member and the first flow path member, and one or a plurality of simulated side branches that are independent of the shunt portion and communicate the cavity and the first flow path with a flow path cross-sectional area narrower than a flow path cross-sectional area of the shunt portion; and
flowing liquid through the second flow path at a pressure higher than a pressure of the first flow path.
